(19) United States
(12) Patent Application Publication
(10) Pub. No.: US 2025/0237748 A1
(43) Pub. Date: Jul. 24, 2025

(54) MINIATURIZED DIFFUSER-DRIVEN ACTIVE INFRARED (IR) SENSOR

(71) Applicant: Sloan Valve Company, Franklin Park, IL (US)

(72) Inventors: Xiaoxiong Mo, Lexington, MA (US); Marcos Berrios, Somerville, MA (US); Jay Perlin, Hollis, NH (US); Eric Shen, Bedford, MA (US); Joseph Collins, Worcester, MA (US); Dennis Folliard, Libertyville, IL (US); John Kirk, Boxford, MA (US); Helen Chen, Lexington, MA (US); Nicholas Schneider, North Andover, MA (US); Sheng Deng, Lexington, MA (US)

(21) Appl. No.: 19/034,816

(22) Filed: Jan. 23, 2025

Related U.S. Application Data
(60) Provisional application No. 63/624,321, filed on Jan. 24, 2024.

(51) Int. Cl. G01S 7/481; G01S 17/04

(52) U.S. Cl. CPC G01S 7/4815; G01S 7/4813; G01S 7/4816; G01S 17/04

(57) ABSTRACT

The present disclosure describes a sensor comprising a first transmitter, a second transmitter, and a receiver. The first transmitter may be configured to emit first light via a first diffractive or refractive material, and the second transmitter may be configured to emit second light via a second diffractive or refractive material. The first diffractive or refractive material and/or the second diffractive or refractive material may be configured to deflect and/or shape light to focus the light in a detection zone. Light reflected by an intended target may be received (e.g., detected) by the receiver. Upon detecting a target, the sensor may cause a device to perform an action. The sensor may be deployed in a plurality of devices, including Internet-of-Things (IoT) devices that have WiFi capabilities. The WiFi capabilities may comprise a bridge-less architecture that allows the IoT devices to communicate with cloud services for remote monitoring purposes.

### CROSS-REFERENCE TO RELATED APPLICATIONS

This application claims priority to U.S. Provisional Application No. 63/624,321, filed on Jan. 24, 2024 and entitled “Miniaturized Diffuser-Driven Active Infrared (IR) Sensor,” the entirety of which is hereby incorporated by reference for all purposes.

### FIELD OF THE INVENTION

Aspects of the disclosure generally relate to infrared sensors and, more specifically, to diffuser-driven infrared (IR) sensors.

### BACKGROUND OF THE INVENTION

Infrared (IR) sensors are used in a variety of appliances to allow the appliances to operate in a touchless, or near touchless, manner. However, the size and/or bulkiness of existing IR sensors prevents them from being used in certain applications. Moreover, existing IR sensors encounter problems with obstacles when implemented in faucets or other bathroom fixtures, as well as water dispensers, water fountains, bottle fillers, water bubblers, and the like. These obstacles may include streams of water or other fixtures that are proximately located to the IR sensor. These obstacles may reduce the accuracy of the IR sensors, which results in the appliance's inability to operate in a touchless manner.

### SUMMARY OF THE INVENTION

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may relate to miniaturized infrared (IR) sensors and, more specifically, to diffuser-driven IR sensors. The present disclosure describes a miniaturized IR sensor assembly that may be implemented in a plurality of near-field appliances, such as faucets, soap dispensers, hand dryers, paper towel dispensers, flushometers, air fresheners, water dispensers, water fountains, bottle fillers, water bubblers, and equivalents thereof. The miniature sensor described herein may use one or more planar optical films to direct IR light such that the IR light avoids obstacles, such as a water stream from a faucet, as well as sinks, countertops, and any other obstacles that may be problematic.

The active IR sensor may comprise a first IR transmitter, a second IR transmitter, and a photodiode. The first IR transmitter may be configured to emit first IR light, and the second IR transmitter may be configured to emit second IR light. The active IR sensor may comprise a first diffuser configured to bend the first IR light in a first direction. The first diffuser may comprise a first ultra-thin, asymmetric angle bend diffuser configured to control a first illumination pattern of the first IR light to more accurately detect objects of interest while avoiding sources of potential false-trigger. The second IR transmitter may comprise a second diffuser configured to bend the second IR light in a second direction that is different from the first direction. The second diffuser may comprise a second ultra-thin, asymmetric angle bend diffuser configured to control a second illumination pattern of the second IR light to more accurately detect objects of interest while avoiding sources of potential false-trigger. The first diffuser and/or the second diffuser may be configured to deflect and/or shape light as the IR light is emitted by the first IR transmitter and the second IR transmitter. Light reflected by an intended target may be received (e.g., detected) by the photodiode. The photodiode may be a wide-angle photodiode that is equipped with time-gated readout that allows for distinction between the light of the first IR transmitter and the second IR transmitter.

According to some aspects of the disclosure, the first diffuser and/or the second diffuser may comprise one or more interchangeable diffuser films. The one or more interchangeable diffuser films may be swapped to allow for different deflection angles. Different deflection angles may allow the active IR sensor to be adapted for use in a variety of applications, such as forward and downward facing sensor locations, such as those found in faucets and soap dispensers.

In some aspects of the disclosure, the active IR sensor may comprise a split window housing design. The split window housing may comprise two different materials. A first material, located over the first IR transmitter, the second IR transmitter, and/or the receiver, may be transparent or translucent (e.g., semi-transparent) in the IR spectrum. The rest of the split window housing may comprise a second material that is opaque to all light, including visible light and IR light. The rest of the split window housing may comprise a wall separating the first IR transmitter and the second IR transmitter from the photodiode. The wall may be constructed from the second material. The combination of the second material and the wall may reduce crosstalk and prevent false activations and/or other operational issues.

In yet a further aspect of the disclosure, the active IR sensor may comprise a first IR transmitter, a second IR transmitter, a first lens configured to direct first light emitted from the first IR transmitter, a second lens configured to direct second light emitted from the second IR transmitter, a photodiode, and a third lens configured to direct (e.g., focus) reflected light on to the photodiode. The first lens and/or the second lens may be configured to direct the first and second light to either side of a water stream. According to some examples, the first lens and the second lens may comprise a pair of prisms with lenses molded into the bottom prism surfaces to reduce reflections off of the water stream that would degrade sensor performance. The lens/prism combinations may be molded directly into an interior surface of the sensor housing. As noted above, light emitted from the first IR transmitter and/or the second IR transmitter may be reflected off a target (e.g., a user's hands). As noted above, the third lens may be used to focus the reflected light from the target onto the photodiode. The third lens may be a lens/prism combination, similar to the first lens and/or second lens described above. The third lens may be molded into the interior surface of the sensor housing, for example, above the photodiode. The photodiode may be equipped with time-gated readout that allows for distinction between first light from the first IR transmitter and second light from the second IR transmitter.

These features, along with many others, are discussed in greater detail below.

### BRIEF DESCRIPTION OF DRAWINGS

The present disclosure is illustrated by way of example and not limited in the accompanying figures in which like reference numerals indicate similar elements and in which:

FIGS. 1A-1C show example environments where the active infrared (IR) sensor described herein may be implemented;

FIGS. 2A-2B show an example use case for the active IR sensor described herein in accordance with one or more aspects of the disclosure;

FIGS. 3A-3F show an example of the active IR sensor circuitry according to one or more aspects of the disclosure;

FIGS. 4A-4E show another example of the active IR sensor circuitry according to one or more aspects of the disclosure;

FIG. 5 shows an example of a housing for the active IR circuitry;

FIGS. 6A-6B show an example of a faucet implementing the active IR sensor in accordance with one or more aspects of the disclosure; and

FIGS. 7A-7B show an example of a bottle filling station implementing the active IR sensor in accordance with one or more aspects of the disclosure.

### DETAILED DESCRIPTION OF THE INVENTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

The present disclosure describes miniaturized infrared (IR) sensors and, more specifically, diffuser-driven IR sensors. The present disclosure describes a miniaturized IR sensor assembly that may be implemented in a plurality of near-field appliances, such as faucets, soap dispensers, hand dryers, paper towel dispensers, flushometers, air fresheners, water dispensers, water fountains, bottle fillers, water bubblers, and equivalents thereof. The miniature sensor described herein may use one or more planar optical films to direct IR light such that the IR light avoids obstacles, such as a water stream from a faucet, as well as sinks, countertops, and any other obstacles that may be problematic.

The active IR sensor may comprise a first IR transmitter, a second IR transmitter, and a photodiode. The first IR transmitter may be configured to emit first IR light, and the second IR transmitter may be configured to emit second IR light. The active IR sensor may comprise a first diffuser configured to bend the first IR light in a first direction. The first diffuser may comprise a first ultra-thin, asymmetric angle bend diffuser configured to control a first illumination pattern of the first IR light to more accurately detect objects of interest while avoiding sources of potential false-trigger. The second IR transmitter may comprise a second diffuser configured to bend the second IR light in a second direction that is different from the first direction. The second diffuser may comprise a second ultra-thin, asymmetric angle bend diffuser configured to control a second illumination pattern of the second IR light to more accurately detect objects of interest while avoiding sources of potential false-trigger. The first diffuser and/or the second diffuser may be configured to deflect and/or shape light as the IR light is emitted by the first IR transmitter and the second IR transmitter. Light reflected by an intended target may be received (e.g., detected) by the photodiode. The photodiode may be a wide-angle photodiode that is equipped with time-gated readout that allows for distinction between the light of the first IR transmitter and the second IR transmitter.

According to some aspects of the disclosure, the first diffuser and/or the second diffuser may comprise one or more interchangeable diffuser films. The one or more interchangeable diffuser films may be swapped to allow for different deflection angles. Different deflection angles may allow the active IR sensor to be adapted for use in a variety of applications, such as forward and downward facing sensor location faucets.

In some aspects of the disclosure, the active IR sensor may comprise a split window housing design. The split window housing may comprise two different materials. A first material, located over the first IR transmitter, the second IR transmitter, and/or the receiver, may be transparent or translucent (e.g., semi-transparent) in the IR spectrum. The rest of the split window housing may comprise a second material that is opaque to all light, including visible light and IR light. The rest of the split window housing may comprise a wall separating the first IR transmitter and the second IR transmitter from the photodiode. The wall may be constructed from the second material. The combination of the second material and the wall may reduce crosstalk and prevent false activations and/or other operational issues.

In yet a further aspect of the disclosure, the active IR sensor may comprise a first IR transmitter, a second IR transmitter, a first lens configured to direct first light emitted from the first IR transmitter, a second lens configured to direct second light emitted from the second IR transmitter, a photodiode, and a third lens configured to direct (e.g., focus) reflected light on to the photodiode. The first lens and/or the second lens may be configured to direct the first and second light to either side of a water stream. According to some examples, the first lens and the second lens may comprise a pair of prisms with lenses molded into the bottom prism surfaces to reduce reflections off of the water stream that would degrade sensor performance. The lens/prism combinations may be molded directly into an interior surface of the sensor housing. As noted above, light emitted from the first IR transmitter and/or the second IR transmitter may be reflected off a target (e.g., a user's hands). As noted above, the third lens may be used to focus the reflected light from the target onto the photodiode. The third lens may be a lens/prism combination, similar to the first lens and/or second lens described above. The third lens may be molded into the interior surface of the sensor housing, for example, above the photodiode. The photodiode may be equipped with time-gated readout that allows for distinction between first light from the first IR transmitter and second light from the second IR transmitter.

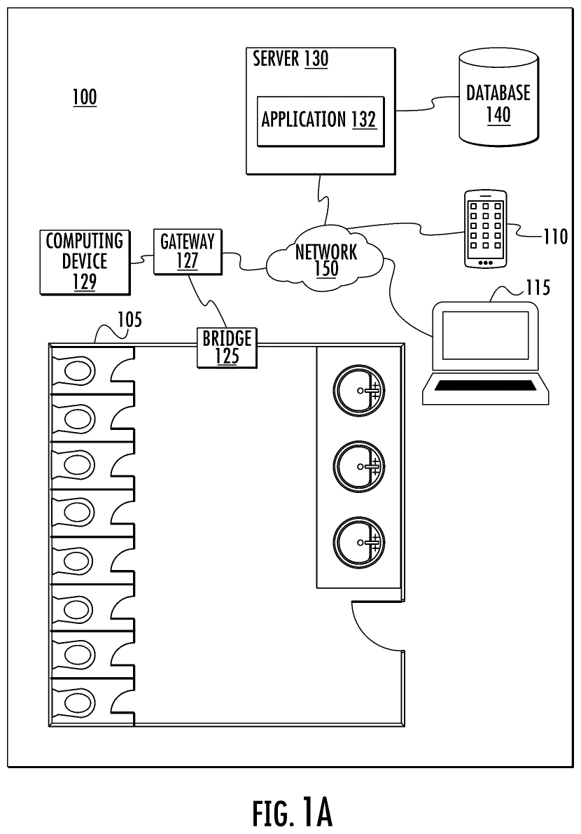

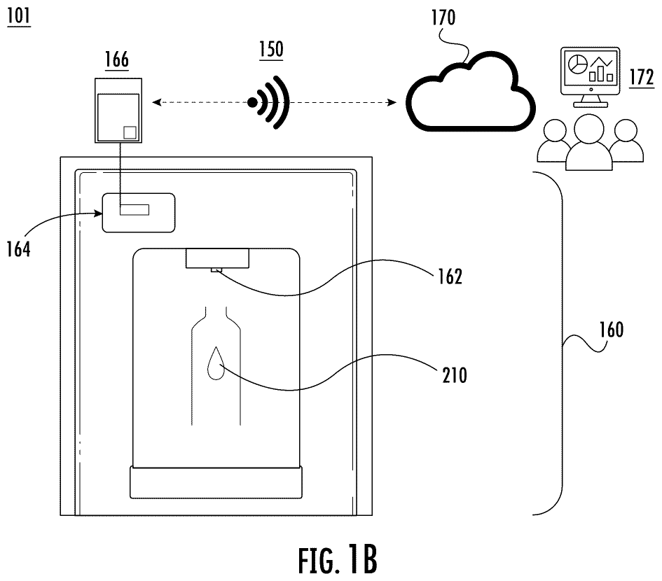

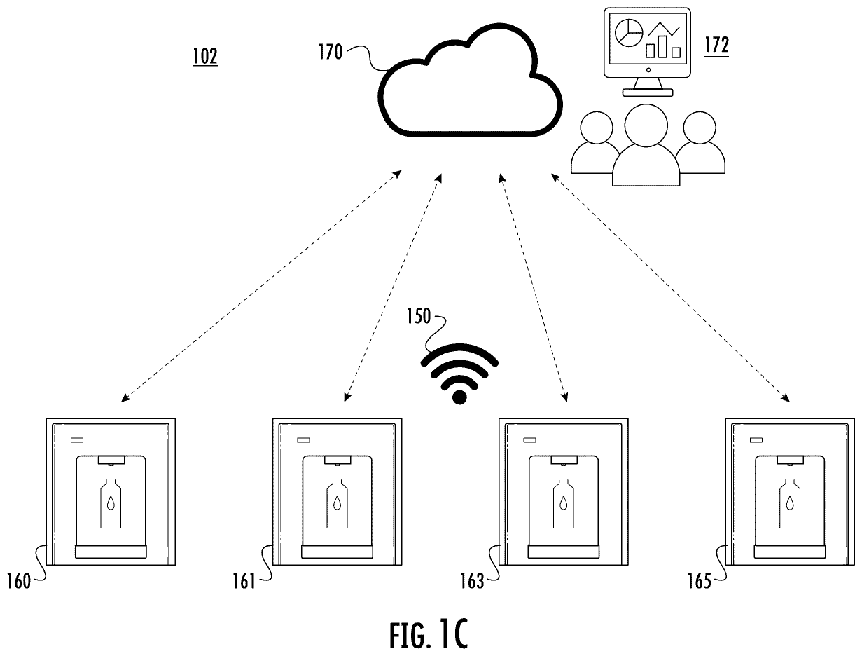

FIG. 1A shows an environment 100 where the infrared (IR) sensor described herein may be implemented. As shown in FIG. 1A, the environment 100 comprises a restroom 105, a first user device 110, a second user device 115, and a server 130 interconnected via network 150.

Restroom 105 may be a bathroom in a commercial space, such as an office building, a retailer (e.g., mall), a stadium, etc. The restroom 105 may comprise a plurality of water closets and a plurality of sinks. Although not shown in FIG. 1, the restroom 105 may also comprise urinals, hand dryers, hand sanitation units, etc. (individually referred to as a “fixture,” and collectively as “fixtures”). Each fixture may comprise one or more sensors (not shown). Each sensor, of the one or more sensors, may allow a respective fixture to operate in a touchless manner. The one or more sensors may be integral to each of the fixtures. The fixtures and/or the one or more sensors may be hardwired into a building's electrical supply. Alternatively, the fixtures and/or the one or more of sensors may be battery-operated. In yet further examples, the fixtures and/or the one or more of sensors may receive power from a low-voltage power supply, such as power-over-ethernet (POE) or from a transformer located in the restroom 105. As will be discussed in greater detail below, each of the one or more sensors may have a field of view associated therewith. The one or more sensors may cause the fixture to activate in response to detecting an object in the field of view. Additionally or alternatively, the one or more sensors may cause the fixture to activate in response to detecting an object leave the field of view. For example, upon detecting a user, a first sensor associated with a faucet may cause the faucet to turn on. When the first sensor no longer detects the user within its field of view, the faucet may turn off. Accordingly, each of the one or more sensors may determine when a fixture has been activated (e.g., a toilet, or urinal, flushed, a sink turned on/off, a hand dryer activated, a paper towel dispenser activated, etc.). In some instances, the one or more sensors may send usage information to a computing device, such as a local computing device 129 and/or the server 130. The local computing device 129 may be a computing device, such as a server, a user device, a location smart display monitor, or any combination thereof, located on the same premises as the restroom 105. The usage information may be sent to the local computing device 129 via the bridge 125. Additionally or alternatively, the usage information may be sent via bridge 125 and/or gateway 127 to the server 130. By transmitting the usage information to the computing device (e.g., the local computing device 129 and/or the server 130), the computing device (e.g., the local computing device 129 and/or the server 130) may be able to ascertain real-time usage data associated with the restroom 105.

Bridge 125 may be configured to connect one or more fixtures via a network. The network may be a local area network, such as a building or corporate network. The bridge 125 may be a wired or wireless bridge. In preferred embodiments, the bridge 125 comprises a wireless interface to communicate (e.g., send/receive) with one or more fixtures. The wireless interface may use a short-range wireless communication protocol, such as Bluetooth® communications, Bluetooth® Low Energy communications, Wi-Fi communications, ANT communications, LoRa communications, Zig Bee Communications, or any equivalent thereof.

Gateway 127 may be configured to connect the network (e.g., building or corporate network) to a wide area network, such as network 150. The gateway 127 may provide interoperability between building or corporate network and network 150. The gateway 127 may comprise protocol translators, impedance matchers, rate converters, fault isolators, or signal translators. In some examples, the gateway 127 may perform protocol conversions to connect networks with different network protocol technologies.

First user device 110 may be a mobile device, such as a cellular phone, a mobile phone, a smart phone, a tablet, a laptop, or an equivalent thereof. First user device 110 may provide a first user with access to various applications and services. For example, first user device 110 may provide the first user with access to the Internet. Additionally, first user device 110 may provide the first user with one or more applications (“apps”) located thereon. The one or more applications may provide the first user with a plurality of tools and access to a variety of services. In some embodiments, the one or more applications may include an application that provides access to a dashboard, or portal, that provides information about restroom occupancy and/or plumbing fixtures. As noted herein, the information may include usage and/or statistics about a restroom's usage. The information may also comprise critical diagnostics. Additionally or alternatively, the information may include information about individual fixtures, including, for example, real-time information about whether a fixture is currently being used. The application may comprise an authentication process to verify (e.g., authenticate) the identity of the first user prior to granting access to the dashboard (e.g. portal) 172.

Second user device 115 may be a device configured to allow a user to execute software for a variety of purposes. Second user device 115 may belong to the first user that accesses first user device 110, or, alternatively, second user device 115 may belong to a second user, different from the first user. Second user device 115 may be a desktop computer, laptop computer, or, alternatively, a virtual computer. The software of second user device 115 may include one or more web browsers that provide access to websites on the Internet. These websites may include plumbing websites that allow the user to view information about a building's plumbing, an individual bathroom, and/or an individual fixture. In some embodiments, second user device 115 may include an application that allows the user to access a dashboard 172, or portal, to view information about a building's plumbing, an individual bathroom, and/or an individual fixture. As noted above, the information may comprise critical diagnostics about the plumbing fixtures. The website and/or the application may comprise an authentication component to verify (e.g., authenticate) the identity of the second user prior to granting access to the dashboard 172 (e.g., portal).

Server 130 may be any server capable of executing application 132. Additionally, server 130 may be communicatively coupled to a database 140. In this regard, server 130 may be a stand-alone server, a corporate server, or a server located in a server farm or cloud-computer environment. According to some examples, server 130 may be a virtual server hosted on hardware capable of supporting a plurality of virtual servers. In some instances, the server 130 may be hosted by a commercial plumbing supply company, such as Sloan Valve Company. The server 130 may be hosted in a cloud provider, such as Microsoft Azure Cloud Service or an equivalent thereof. The server may execute application 132 on behalf of one or more consumers of the products manufactured and distributed by the commercial plumbing supply company.

The application 132 may be server-based software configured to provide users with information about restroom 105. In some embodiments, the application 132 may be server-based software that corresponds to client-based software executing on first user device 110 and/or second user device 115. Additionally, or alternatively, the application 132 may provide users access to the information through a website, or portal, accessed by first user device 110 or second user device 115 via network 150. The application 132 may comprise an authentication module to verify users before granting access to the information. The information may include a start time of the fixture's usage, an end time of the fixture's usage, a duration of the fixture's usage, etc. The application 132 may also analyze the information from a plurality of fixtures associated with a location and present the analysis to a user, for example, via the dashboard 172. That is, the application 132 may receive information from each of a plurality of fixtures located in a restroom (e.g., restroom 105). The application 132 may then analyze the information associated with the restroom and present the analysis to a user, via the dashboard 172. The application 132 may provide the analysis with respect to individual restrooms. Additionally or alternatively, the application may provide the analysis for a building, as-a-whole, showing usage and/or statistics for all of the restrooms located in a building. It will be appreciated that the dashboard 172 may allow a user to view usage and/or statistics about the building as-a-whole, while allowing the user to also focus on individual restrooms and/or fixtures. In this regard, the dashboard 172 may provide an overall view of the plumbing of a building, as well as granular data and/or information for individual fixtures. The application 132 may also provide real-time information regarding whether a fixture is currently in use. Further, the dashboard 172 may generate notifications, for example, if a restroom and/or fixture requires attention. The notifications may be an electronic communication, such as an email, a text message, a push notification, etc. Additionally or alternatively, the notifications may be displayed via an alert in the dashboard 172 or location smart display monitor.

The database 140 may be configured to store information on behalf of application 132. The information may include, but is not limited to, data about restrooms, such as the quantity, type, model numbers, etc. of the fixtures associated with a restroom. Additionally or alternatively, the information stored in database 140 may comprise usage and/or statistics of each fixture. User-preferences may also be stored in the database 140. The user-preferences may define how users receive notifications, alerts, etc. The database 140 may include, but is not limited to relational databases, hierarchical databases, distributed databases, in-memory databases, flat file databases, XML databases, NoSQL databases, graph databases, and/or a combination thereof.

Network 150 may include any type of network. In this regard, first network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in environment 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the environment 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in environment 100 in front of one or more computing devices such that any external devices may communicate directly with the specialized hardware.

FIG. 1B shows another environment 101 in which the IR sensor may be implemented. As shown in FIG. 1B, the environment 101 comprises a bottle filling station 160 connected to a cloud service 170 via network 150. Network 150 may be the same, or similar, to network 150 described above.

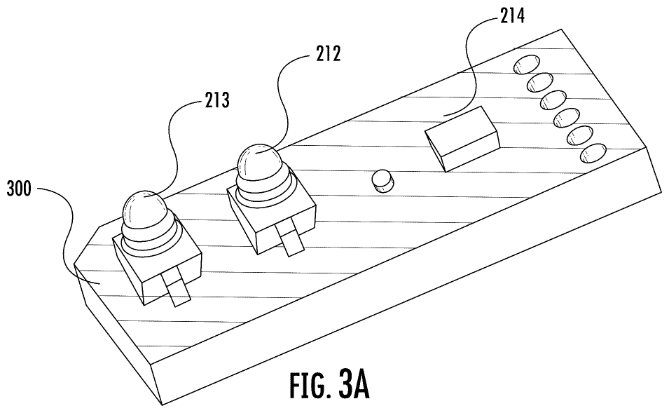

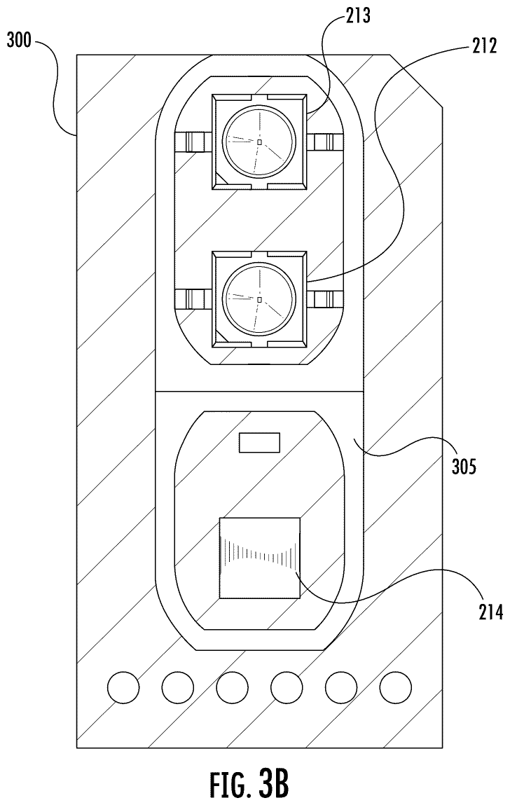

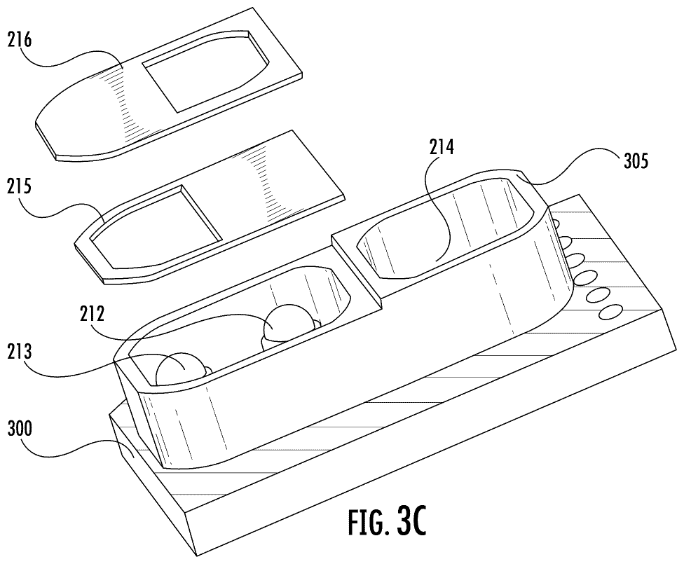

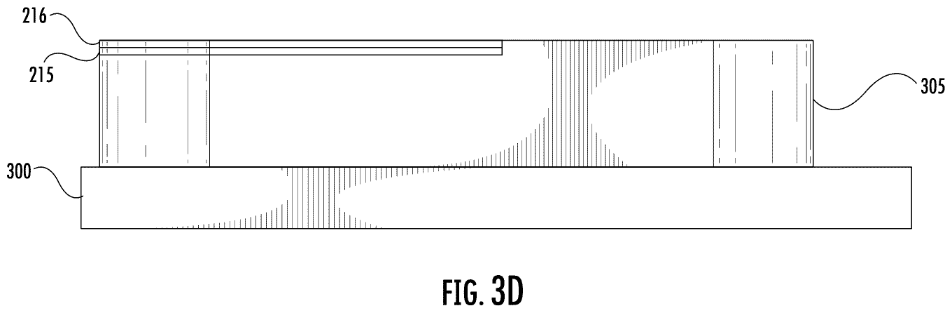

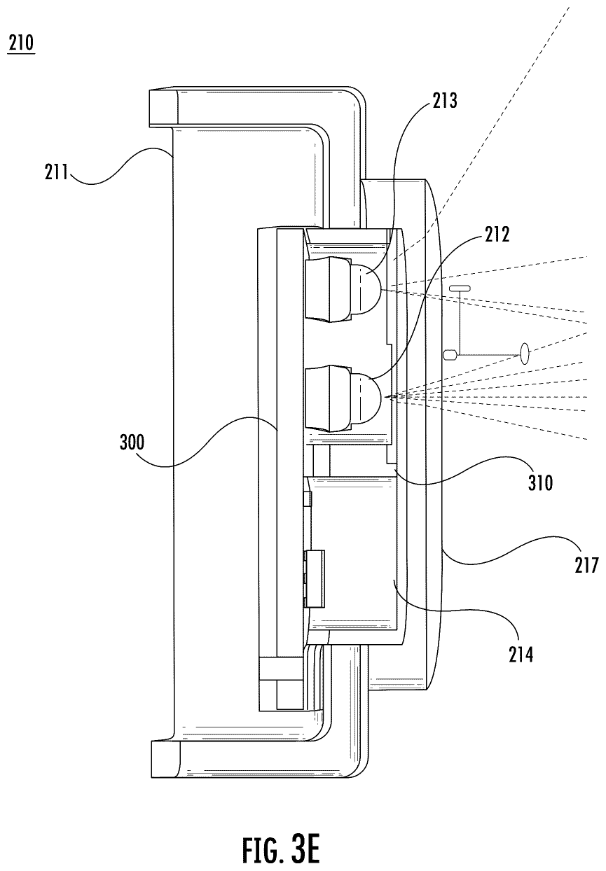

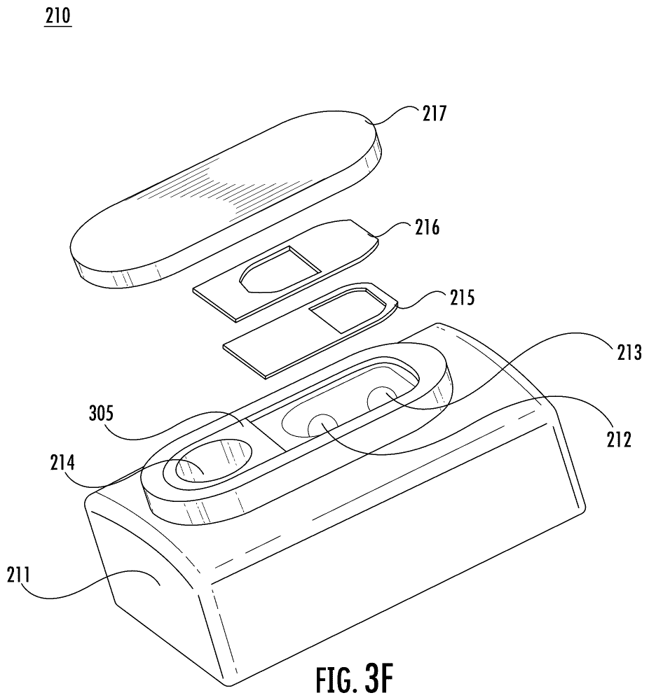

Bottle filling station 160 may be sensor-activated and Internet-of-Things (IoT)-enabled. IoT capability may enable the bottle filling station 160 to be monitored and/or managed remotely from a central dashboard. Traditionally, water dispensers, like bottle filling station 160, may comprise one or more serviceable items, such as water filters. While water dispensers typically include visual indicators—such as a filter status indicator LED or LEDs on the water dispenser unit that indicates if the filter needs to be replaced, these visual indicators require service personnel to manually check each unit, which may result in filters being due for replacement for a period of time before service personnel are aware of the need for replacement. The present disclosure describes using IoT connectivity to enable filter status to be communicated to a central dashboard and notifications and alerts to be viewed and sent to relevant personnel as needed to ensure maintenance is performed in a timely manner. To realize these improvements, bottle filling station 160 may comprise a water dispensing unit 162, an electronic printed circuit board (PCB) assembly 164, and a sensor 210. Sensor 210 will be discussed in greater detail below with respect to FIGS. 3A-3F.

Bottle filling station 160 may comprise a main cabinet and an alcove. The main cabinet may be made of stainless steel or any other suitable and/or equivalent metal. To ensure sufficient radio frequency signal range, the alcove may be made of plastic or any other suitable and/or equivalent material that is capable of allowing radio frequency signals to pass through without significant degradation to the radio frequency signals. Bottle filling station 160 may comprise a bridge-less architecture that allows bottle filling station 160 to communicate with cloud service 170. Accordingly, bottle filling station 160 may have a wireless transmitter configured to a range of approximately 150 feet to communicate with a local WiFi router. Water dispensing unit 162 may comprise an aerator or any other mechanism configured to dispense water or other fluids. Water dispensing unit 162 may comprise a spigot, a faucet, a valve, and the like.

Bottle filling station 160 may also comprise electronic PCB assembly 164, which may control the operation and/or maintain information related to the bottle filling station 160. In operation, electronic PCB assembly 164 may be connected to sensor 210. As will be discussed in greater detail below, sensor 210 may be any suitable sensor configured to detect the presence of a user and/or a bottle or a cup. Electronic PCB assembly 164 may receive presence information from the sensor 210. In response to receiving presence information, electronic PCB assembly 164 may actuate a solenoid valve to dispense water via water dispensing unit 162. The water dispensing path (not shown) may comprise a supply line path, a water filter, the solenoid valve, and/or a flow regulating aerator (e.g., water dispensing unit 162) where the water is dispensed exterior to the unit into a bottle or cup. Electronic PCB assembly 164 may also monitor the on-time status of the solenoid valve to calculate a volume of water dispensed from the solenoid valve and/or the flow rate that is regulated by the aerator (e.g., water dispensing unit 162). The total volume of water flow through the unit may be tracked for the bottle filling station 160. The total volume of water flow may be used to determine various maintenance needs of the bottle filling station 160, including, for example, when the water filter needs to be replaced (e.g., at 3000 gallons). When the filter is replaced by service personnel, a button that interfaces to the electronic PCB assembly 164 may be used to reset the filter status (i.e., set the accumulated volume of water to zero). Additionally or alternatively, the electronic PCB assembly 164 may monitor other operational data to keep track of number of bottles saved, number of activations, total activation run time, average activation run time, sensor status, etc.

Electronic PCB assembly 164 may comprise a communication interface 166. The communication interface 166 may comprise one or more integrated circuits and/or chipsets configured to enable bottle filling station 160 to communicate with cloud service 170. Communication interface 166 may be mounted to the electronic PCB assembly 164. The communication interface 166 may comprise software that allows the communication interface 166 to communicate with cloud service 170. As shown in FIG. 1B, communication interface 166 may comprise a wireless communication interface (e.g., radio transmitter). Preferably, communication interface 166 comprises an ESP32-mini-1 WiFi chip located on electronic PCB assembly 164. The wireless communication interface may communicate using any suitable wireless communication protocol, such as Bluetooth® communications, Bluetooth® Low Energy communications, Wi-Fi communications, ANT communications, LoRa communications, Zig Bee Communications, or any equivalent thereof. Alternatively, communication interface 166 may comprise a wired interface to allow the wired communication interface to communicate using any suitable wired communication protocol, such as TCP/IP, Ethernet, FTP, HTTP and the like. Communication module 166 may comprise software and/or firmware configured to manage communications from the bottle filling station 160 to the cloud service 170, via network 150. As noted above, because radio frequency signals would propagate to/from communication interface 166, it is important that external interfaces of bottle filling station 160 be comprised of plastic or any other suitable non-metallic material to allow for radio frequency signal to propagate with minimal attenuation.

Cloud service 170 may be configured to receive from signals from bottle filling station 160. Similarly, cloud service 170 may be configured to transmit signals to bottle filling station 160. Cloud service 170 may be any suitable cloud provider, such as such as Microsoft Azure Cloud Service, Blynk IoT, or an equivalent thereof. Cloud service 170 may provide access to a dashboard 172 (e.g., a portal) that provides information about bottle filling station 160. Information about bottle filling station 160 may include, for example, number of activations (since water filter change); average activation run time length; total run time (since manufacture/installation); total run time (since filter change); line flush after set number of hours without activation; an indication of when a remote activation command was executed; bottle filler displays number of plastic water bottles replaced, number of plastic water bottles replaced displayed in IoT report; a signal that a filter change has occurred; sensor range; sensor range adjustments; model number; date of manufacture; bottle filler notes for maintenance, location, etc.; water filter status notifications (e.g., at 2,700 gallons through filter); water filter status alarm (e.g., at 3000 gallons through filter); notification and/or alarm clears when filter is changed; alert for loss of communication; sensor function(s), plus notification if fails; water usage by device in gallons; water usage for all bottle fillers at a location in gallons; number of activations; number of activations for all bottle fillers at a location; number of bottles saved; total number of bottles saved for all bottle fillers at a location; number of line flushes performed in a set period of time; etc. Dashboard 172 may maintain this information by aggregating data received from one or more bottle filling stations. Dashboard 172 may display data and/or information in different forms (e.g., tables, charts, reports) based on the data that is received from the bottle filling station 160. For example, a water filter status for bottle filling station 160 may be viewed via dashboard 172. Dashboard 172 may also display notifications and/or alerts, for example, when a filter will need to be changed soon and/or when a filter has met its capacity and needs to be changed. In some examples, dashboard 172 may allow a user to actuate certain functionality on bottle filling station 160, including, for example, dispensing water to flush the water line and/or setting the range of sensor 210.

FIG. 1C shows an example of an environment 102, where a plurality of bottle filling stations may be deployed. Environment 102 may comprise an office building, a school, a gym, or another other suitable location where a plurality of bottle filling stations may be installed and/or used. As shown in FIG. 1C, an environment 102 comprises a first bottle filling station 160, a second bottle filling station 161, a third bottle filling station 163, and a fourth bottle filling station 165 communicating with cloud service 170 via network 150. While FIG. 1C shows four bottle filling stations, it will be appreciated that more, or fewer, bottle filling stations may be installed in environment 102. As noted above, each of first bottle filling station 160, second bottle filling station 161, third bottle filling station 163, and fourth bottle filling station 165 may be communicatively coupled to cloud service 170. Each of first bottle filling station 160, second bottle filling station 161, third bottle filling station 163, and fourth bottle filling station 165 may provide data and/or information about each respective bottle filling station to cloud service 170. This data and/or information may include usage data, as well as status information. As noted above, the data and/or information may be displayed via dashboard 172. Based on the data and/or information, additional insights may be discerned. For example, the usage data may indicate which of the bottle filling stations are located in a high traffic area due to increased usage numbers amongst the plurality of bottle filling stations. In some instances, dashboard 172 may display location information for each of the plurality of bottle filling stations.

Although FIGS. 1B and 1C show bottle filling stations, it will be appreciated that the bottle filling stations shown in FIGS. 1B and 1C may be replaced with water fountains, water bubblers, water dispensing units, and the like. Indeed, FIGS. 1B and 1C represent a system of networked, remotely-managed, sensor-activated water dispensers. Each water dispensing unit may be configured with network access to allow bi-directional communications with an IoT cloud and/or one or more remote servers. By having network access, water dispensers may be managed remotely via a dashboard, including monitoring the number of activations, the water filter status, the number of bottles replaced by each water dispensing unit, the sensor status, as well as changing sensor range and remote activation of water, etc. The system shown in FIGS. 1B and 1C uses a bridge-less IoT architecture that allows each water dispensing unit to connect to a cloud service through a network using WiFi or other wireless communication protocols.

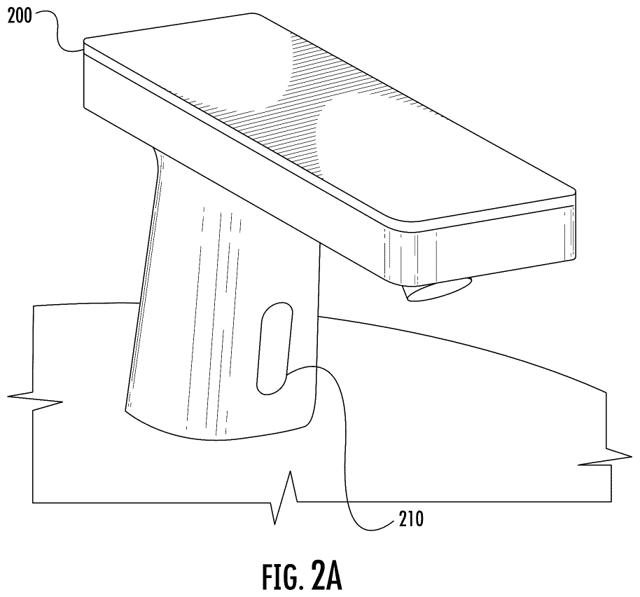

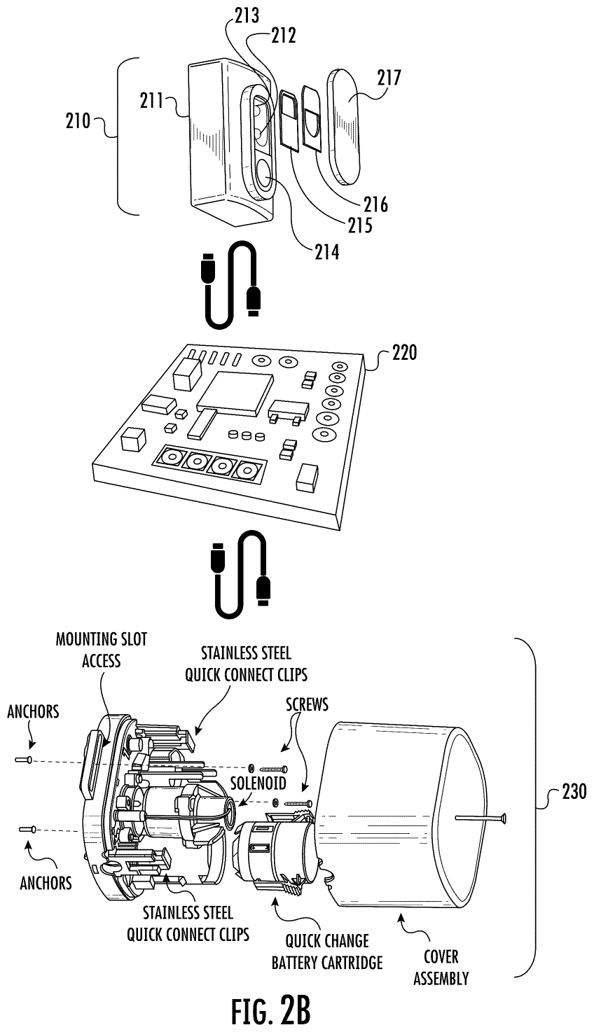

FIGS. 2A-2B show an example use case for the active sensor described herein in accordance with one or more aspects of the disclosure. FIG. 2A shows a faucet 200 comprising a sensor 210. As shown in FIG. 2B, the faucet 200 may comprise the sensor 210, a printed control board (PCB) 220, and a controller 230. Sensor 210 may comprise first transmitter 212, second transmitter 213, receiver 214, first film 215, second film 216, a window 217, and housing 211.

Sensor 210 may comprise a proximity sensor, such as an infrared sensor. Upon detecting the presence, or absence, of the object, sensor 210 may transmit (e.g., send) a signal to PCB 220, which may send a signal to controller 230 to actuate the device. As shown in FIG. 2A, the device is faucet 200. Sensor 210 may send a first signal to controller 230, via PCB 220, to turn on faucet 200 in response to detecting an object (e.g., hands). Similarly, sensor 210 may send a second signal to controller 230, via PCB 220, to turn off faucet 200 in response to no longer detecting the object (e.g., hands). In another example, the device may be a paper towel dispenser. According to this example, sensor 210 may send a signal to controller 230, which may cause a motor to dispense one or more paper towels in response to detecting an object (e.g., hands).

As part of the detection process, first transmitter 212 may be configured to transmit light (e.g., infrared (IR) light) in order to detect the presence, or absence, of an object proximately located near a device. In some instances, first transmitter 212 may comprise one or more light emitting diodes (LEDs). Preferably, first transmitter 212 comprises low powered diode (e.g., LED) configured to emit (e.g., transmit, irradiate) IR light at a steady (e.g., constant, continuous) rate, or a near steady rate. Second transmitter 213 may be similar, or identical, to first transmitter 212. Second transmitter 213 may be configured to work in conjunction with first transmitter 212. Additionally or alternatively, second transmitter 213 may work independent from first transmitter 212. Second transmitter 213 may be configured to operate in a manner substantially similar or equivalent to first transmitter 212. Alternatively, second transmitter 213 may be part a different proximity sensor than first transmitter 212.

Receiver 214 may be another component of sensor 210. Receiver 214 may be a photodiode, a photodetector, or a photoreceptor configured to detect light transmitted by first transmitter 212 and/or second transmitter 213. In some examples, receiver 214 may comprise a wide-angle photodiode that is equipped with a time-gated readout that allows for distinction between first light emitted by first transmitter 212 and the second light emitted by second transmitter 213. Receiver 214 may detect an object proximately located to sensor 210, for example, if a certain amount and/or intensity of light was detected. If the detected light was equal to or greater than a predetermined threshold (e.g., a predetermined number of watts), receiver 214 may cause sensor 210 to transmit (e.g., send) a signal to PCB 220 indicating an object is proximately located near sensor 210. Additionally or alternatively, several thresholds may be used to determine how close the object is to the sensor 210. Indicating an object proximate to sensor 210 may comprise sending (e.g., transmitting) a signal to PCB 220 indicating the presence of the object.

Sensor 210 may comprise a first film 215. First film 215 may be located over first transmitter 212. First film 215 may be configured to direct, or disperse, first light emitted by first transmitter 212. First film 215 may have a cutaway to allow second light emitted from second transmitter 213 to pass without having to pass through first film 215. That is, the cutaway allows the second light to pass without interference. First film 215 may also diffract the first light, for example, towards a detection zone. First film 215 may comprise any suitable material that is rigid enough to be handled during manufacturing but flexible enough that it will not crack during assembly. First film 215 may be less than 1/100th of an inch in thickness. First film 215 may comprise a grating angle that allows light to be directed at a certain angle. According to some examples, first film 215 may cause first light emitted by first transmitter 212 to be bent at 20 degrees from the center of first transmitter 212. Additionally, first film 215 may be configured to be rotated to allow for changes to the direction of the light. By rotating the first film, the detection zone may be changed. First film 215 may comprise a first planar optical film configured to direct first light emitted by first transmitter 212 such that the first light completely avoids the detection of obstacles deemed problematic, such as sinks, and countertops, and a water stream from a faucet. First film 215 may comprise an asymmetric angle bend film. First film 215 may comprise an interchangeable diffuser film. By using interchangeable diffuser films, first film 215 may be swapped for a different film configured to deflect light emitted by first transmitter 212 at a different angle than first film 215. By directing the first light, sensor 210 may operate in a more efficient and/or more accurate manner. Moreover, the ability to easily swap up diffuser films allows for sensor 210 to be easily adapted for use in a variety of applications, such as forward and downward facing sensor locations.

Second film 216 may be similar, or identical, to first film 215. Second film 216 may be located over second transmitter 213 and configured to direct (e.g., redirect, disperse) second light emitted by second transmitter 213. Like first film 215, second film 215 may have a cutaway to allow first light emitted from first transmitter 212 to pass without having to pass through second film 215. The cutaway allows the first light to pass without interference. Second film 215 may also be configured to diffract the second light toward the detection zone. Second film 216 may be less than 1/100th of an inch in thickness. Second film 216 may comprise a grating angle that allows second light to be directed at a certain angle; preferably at 20 degrees from the center of second transmitter 213. Second film 216 may also be configured to rotate to allow for changes to the direction of the light. Second film 216 may comprise a second planar optical film configured to direct second light emitted by second transmitter 213 such that the second light completely avoids the detection of obstacles deemed problematic, such as a water stream from a faucet, sinks, and countertops. Second film 216 may be an interchangeable diffuser film.

First film 215 and second film 216 may be configured to direct light in different directions. Moreover, first film 215 and second film 216 may comprise film shapes that allowed the first film 215 and the second film 216 to be stacked on top of each other, while only allowing each emitter to shine through its own respective film. The ability to rotate and stack films provides flexibility with respect to future applications, where the location of the required detection zone may need to be adjusted.

Sensor 210 may also comprise window 217. Window 217 may be configured to protect first transmitter 212, second transmitter 213, receiver 214, first film 215, and/or second film 216. Window 217 may be made from a material that is translucent or transparent. Preferably, window 217 may comprise a material that is translucent, or transparent, in the IR spectrum. That is, window 217 may be configured to allow IR light to pass, but block light, or other electromagnetic radiation, outside of the IR spectrum.

Housing 211 may comprise any suitable material configured to house at least first transmitter 212, second transmitter 213, receiver 214, first film 215, and/or second film 216. Housing 211 may be made from any suitable material, including plastic. Housing 211 may be opaque. In other words, housing 211 may be made from any material that does not allow light to pass to minimize and/or reduce interference with at least first transmitter 212, second transmitter 213, and/or receiver 214. While shown separately in the figures, it will be appreciated that housing 211 and window 217 may be one integral piece. In some instance, the single integral piece comprising house 211 and window 217 may be made from plastic.

PCB 220 may be any suitable circuit board that is capable of controlling the operation of the device (e.g., faucet 200). Sensor 210 may be communicatively coupled to PCB 220 through any suitable electronic connection. PCB 220 may receive a signal from sensor 210. The signal may indicate that an object is located proximate to the device. In response to receiving the signal, PCB 220 may send another signal to controller 230 to turn on the device. As noted above, the signal from PCB 220 to controller 230 may cause water to be dispensed from faucet 200. Additionally or alternatively, PCB 220 may send a signal to controller 230 to turn off faucet 200, for example, in response to receiving a signal from sensor 210 that the object is no longer detected near the device.

Controller 230 may be an electromechanical component. Controller 230 may be configured to control activation of the device. As shown in FIG. 2B, controller 230 comprises a solenoid, a battery cartridge, a manifold base, and a manifold cover assembly. In the faucet, example shown in FIGS. 2A-2B, the movement of the solenoid may control the flow of water from the faucet. It will be appreciated that controller 230 may have different components. For example, controller 230 may comprise a motor configured to control the distribution of paper towels.

Turning to FIGS. 3A-3F, an example of the circuitry comprising sensor 210 is shown in accordance with one or more aspects of the disclosure. FIG. 3A shows a printed circuit board (PCB) 300 of sensor 210. PCB 300 may comprise first transmitter 212, second transmitter 213, and receiver 214. PCB 300 may be same circuit board as PCB 220, discussed above. Alternatively, PCB 300 may be a circuit board dedicated to the sensor circuitry. According to this example, PCB 300 may connect to, or plug into (e.g., plug-and-play), PCB 220. PCB 300 may comprise an ambient light sensor, proximity, and gesture detector with I2C digital interface and programmable-event interrupt output. PCB 300 may comprise an active optical reflectance proximity detector, with ambient light sensors whose operational state is controlled through registers accessible through the I2C interface. A device (e.g., PCB 220) may initiate ambient light or proximity measurements. Additionally or alternatively, the device (e.g., PCB 220) may operate in an autonomous state where measurements are performed at set intervals and interrupts are generated after each measurement is completed or whenever the sample is larger/smaller than a set threshold. This results in overall system power saving, allowing the device to operate a sleep state, instead of continuously polling PCB 300.

FIG. 3B shows a top view of PCB 300. FIG. 3B also shows the addition of encasing 305. Encasing 305 may be any suitable material configured to compartmentalize the individual components of PCB 300. As shown in FIG. 3B, first transmitter 212 and second transmitter 213 may be grouped in a first compartment, while receiver 214 is set in a second compartment. Encasing 305 may be made from any suitable material, including plastic. Preferably, encasing 305 comprises an opaque material configured to not allow light to pass between the compartments. The opacity of encasing 305 is designed to minimize and/or reduce interference with at least first transmitter 212, second transmitter 213, and/or receiver 214. FIGS. 3C and 3D represent side views of sensor 210 with encasing 305 placed on circuit board 300. FIGS. 3C and 3D also show how first film 215 and second film 216 would be placed on encasing 305, over first transmitter 212 and second transmitter 213.

FIG. 3E shows a side-view of sensor 210 with a cut-away to show the internal circuitry. As noted above, sensor 210 comprises first transmitter 212, second transmitter 213, receiver 214, first film (not shown), second film (not shown), window 217, housing 211, and PCB 300. FIG. 3E also shows wall 310 between a first compartment containing first transmitter 212 and second transmitter 213 and a second compartment containing receiver 214. Wall 310 may be part of encasing 305. Alternatively, wall 310 may be another component, separate from encasing 305. In this regard, wall 310 may comprise an opaque material configured to not allow light to pass between the two compartments. Wall 305 is designed to minimize and/or reduce interference amongst first transmitter 212, second transmitter 213, and/or receiver 214. FIG. 3F shows an exploded view of sensor 210. As illustrated in FIG. 3F, sensor 210 comprises first transmitter 212, second transmitter 213, receiver 214, first film 215, second film 216, window 217, and housing 211. FIG. 3F illustrates another example of how the various components of sensor 210 may be assembled.

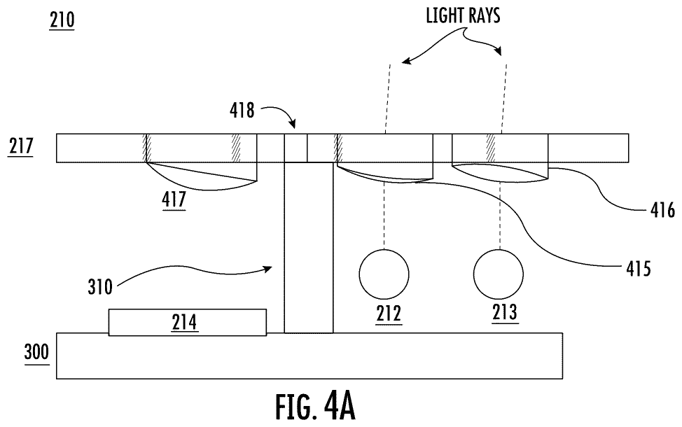

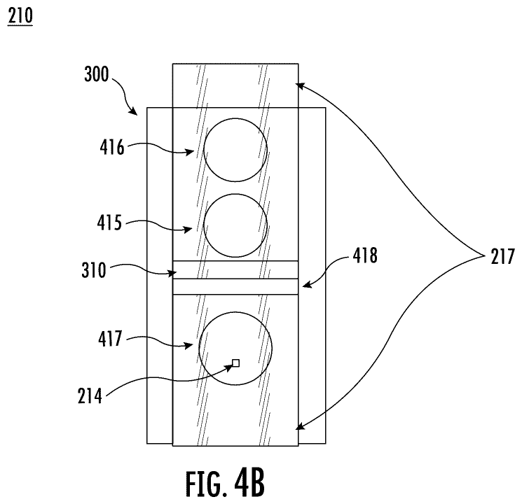

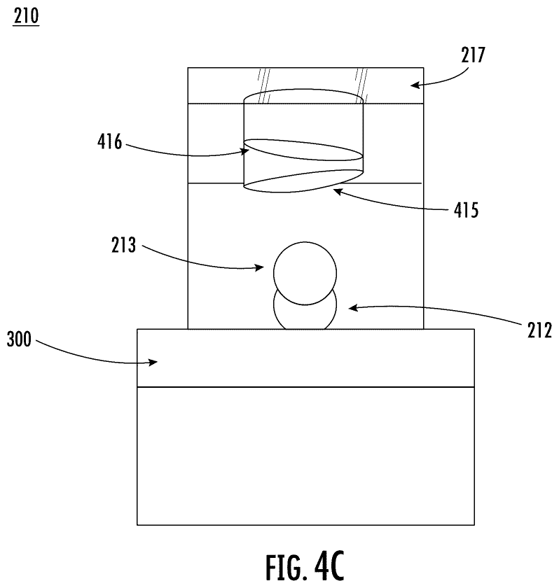

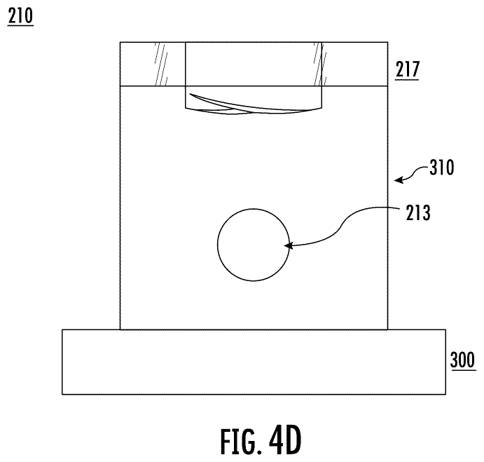

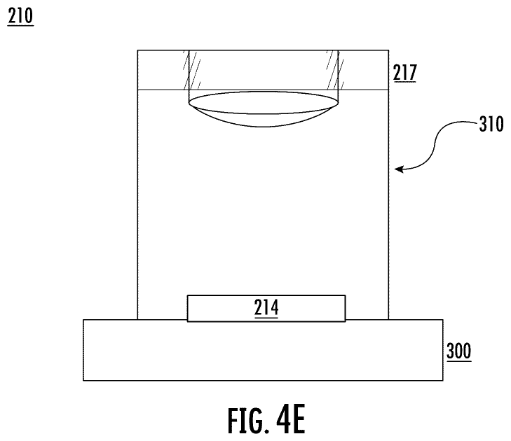

FIGS. 4A-4E show another example of the sensor according to one or more additional aspects of the disclosure. FIGS. 4A-4F show an example of sensor 210 where the first film and the second film have been replaced by lenses (e.g., prisms). As shown in FIG. 4A, sensor 210 comprises first transmitter 212, second transmitter 213, and receiver 214 attached to PCB 300. Sensor 210 also comprises first lens 415, second lens 416, third lens 417, window 217, wall 310, and baffle 418. First transmitter 212, second transmitter 213, receiver 214, window 217, PCB 300, and wall 310 have been discussed above with respect to FIGS. 3A-3F.

FIG. 4A shows a side view of sensor 210 comprising one or more lenses. First lens 415 may be located in the window 217. Additionally or alternatively, first lens 415 may be located in an encasing or a housing. In other words, first lens 415 may be molded directly into an interior surface of the sensor housing. First lens 415 may be configured to direct (e.g., redirect, focus) first light emitted from the first transmitter 212 to avoid obstacles, such as a water stream from a faucet, as well as sinks, countertops, and any other obstacles that may be problematic. According to some examples, first lens 415 may comprise a tilt to redirect first light emitted by first transmitter 212. The tilt may be approximately 10-degrees. By providing for a tilt in first lens 415, first lens may be rotated to adjust, modify, and/or change the direction the first light is emitted.

Second lens 416 may be configured to direct (e.g., redirect) second light emitted from second transmitter 213. Like first lens 415, second lens 416 may be molded directly into a surface of the sensor housing. Second lens 416 may be configured to direct (e.g., redirect) second light emitted by the second transmitter 213. Second lens 416 may also comprise a tilt, which may allow for the sensor and/or the detection zone to be calibrated by rotating second lens 416. This tilt may also be approximately 10-degrees.

First lens 415 and/or second lens 416 may be configured to direct first light and second light on either side of a water stream from a faucet. First lens 415 and second lens 416 may comprise a pair of prisms with lenses molded into the bottom prism surfaces to reduce reflections off of the water stream that would degrade sensor performance. As noted above, first lens 415 and second lens 416 may have angulation and/or tilts that are designed to direct light in a specific direction. Preferably, the light should be directed into a detection zone, where objects are expected to be located for detection purposes. By including the angulation and/or tilts, the detection zone may be adjusted, modified, and/or changed by rotating first lens 415 and/or second lens 416.

Third lens 417 may be configured to direct (e.g., redirect, focus) reflected light on to the receiver 214. In other words, third lens 417 may be used to focus light reflected from a target and/or object onto receiver 214. Third lens 417 may be a lens/prism combination, similar to the first lens 415 and/or second lens 416 described above. Third lens 417 may be molded into the interior surface of the sensor housing, for example, above receiver 417.

Baffle 418 may be configured to prevent crosstalk. Baffle 418 may be part of an injection-molded housing. Additionally or alternatively, baffle 418 may be part of window 217. Baffle 418 may comprise an over molded baffle configured to separate first transmitter 212 and second transmitter 213 from receiver 214. Baffle 418 may reduce crosstalk, which would otherwise produce a great deal of optical noise thereby drastically reducing the range of sensor 210.

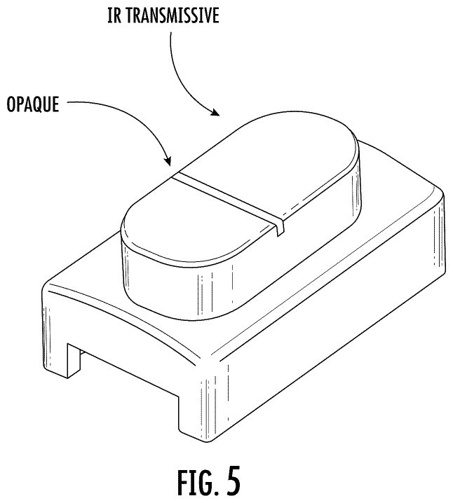

FIG. 5 shows an example of a housing for the sensor 210. The housing shown in FIG. 5 may be an injection-molded housing with an over molded baffle separating the transmitters and the receiver. As noted above, the baffle may reduce crosstalk. FIG. 5 shows an IR transmissive portion and an opaque wall. The opaque wall may be configured to reduce crosstalk.

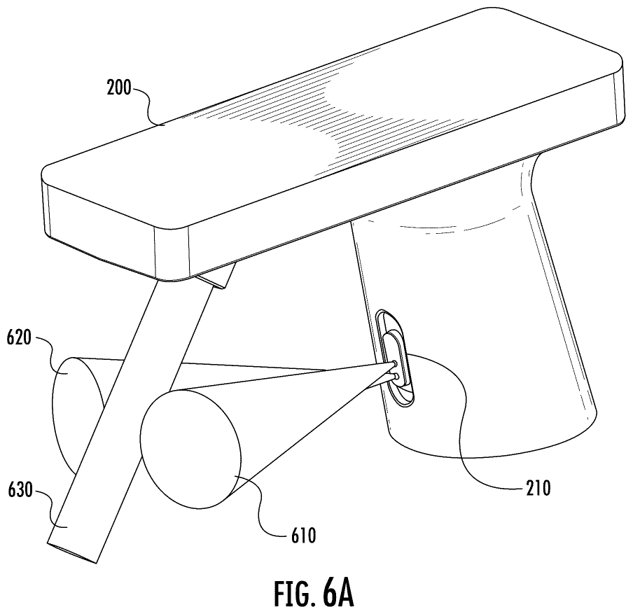

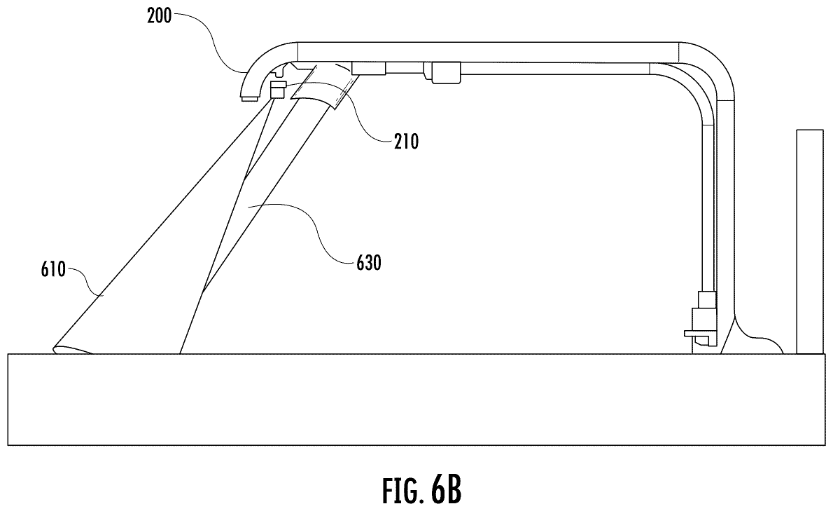

FIGS. 6A-6B show an example of a faucet implementing the active IR sensor in accordance with one or more aspects of the disclosure. FIG. 6A shows faucet 200 with sensor 210. Sensor 210 is a forward-facing sensor. Sensor 210 may emit first beam of light 610 and second beam of light 620 around stream of water 630. As discussed above, first beam of light 610 and second beam of light 620 may be directed into a detection zone, while avoiding stream of water 630. In this regard, first beam of light 610 and/or second beam of light 620 may be designed to detect hands, or other objects, adjacent and/or in stream of water 630.

FIG. 6B shows another example of faucet 200 with sensor 210 where sensor 210 is a downward-facing sensor. Like the example shown in FIG. 6A, sensor 210 may emit first beam of light 610 and second beam of light 620 around stream of water 630. The first beam of light 610 and second beam of light 620 may be directed into a detection zone that avoids stream of water 630 while still being capable of detecting hands, or other objects, adjacent and/or in stream of water 630.

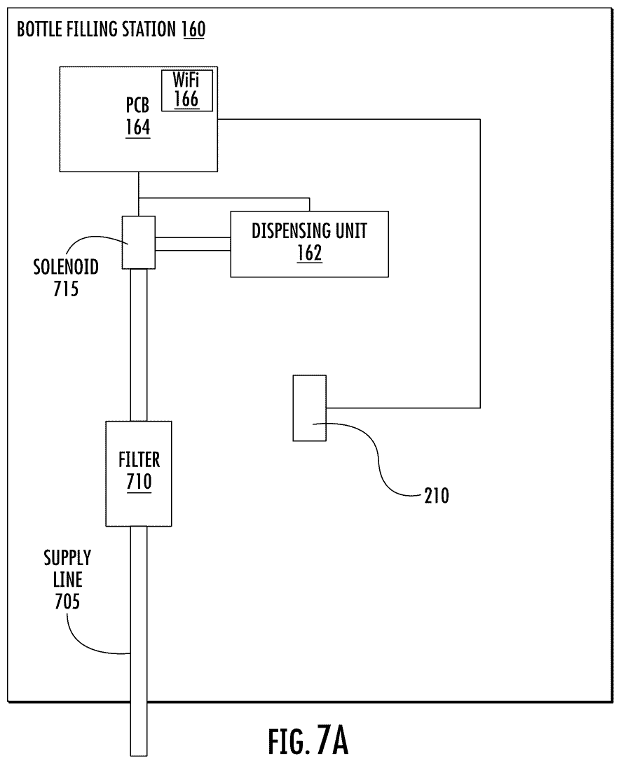

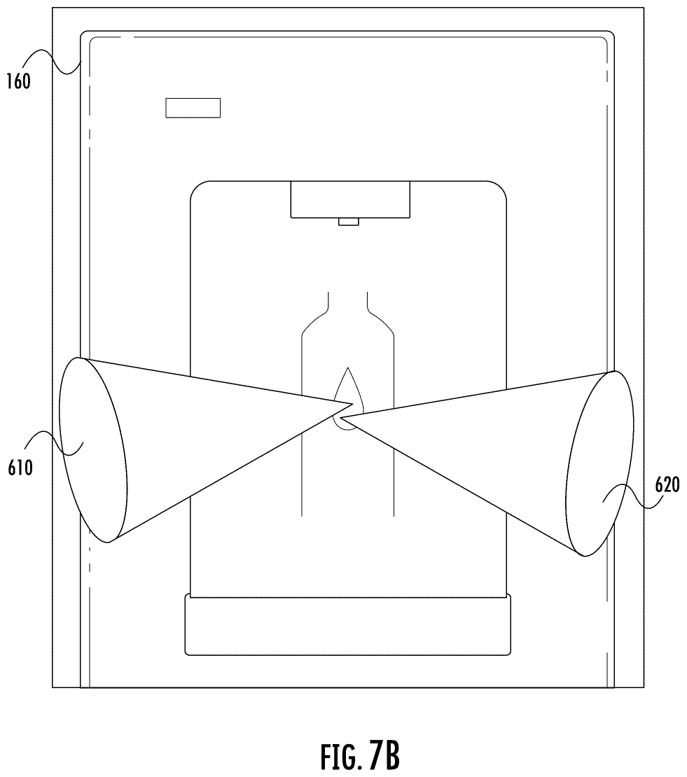

FIGS. 7A-7B show an example of a bottle filling station implementing the sensor described herein in accordance with one or more aspects of the disclosure. FIGS. 7A-7B show Bottle filling station 160. As discussed above, Bottle filling station 160 comprises dispensing unit 162, PCB assembly 164, communication interface 166, and sensor 210. As shown in FIG. 7A, sensor 210 may not have a first film or a second film. Similarly, sensor 210 may not have a first lens, a second lens, and a third lens. In these examples, the light emitted by the transmitters would not be redirected, but instead aim straight ahead to detect objects directly located in front of sensor 210. Bottle filling station 160 may also comprise supply line 705, filter 710, and solenoid 715. Supply line 705 may connect to a line that supplies various fixtures with water. Filter 710 may comprise a replaceable and/or disposable filter. Filter 710 may comprise a carbon-based filter. Filter 710 may be designed to filter approximately 3,000 gallons of water before needing to be replaced. Solenoid 715 may be configured to control the flow of water from Bottle filling station 160. As noted above, the movement of solenoid 715 may cause water to flow from dispensing unit 162, for example, in response to sensor 210 detecting an object (e.g., a bottle).

FIG. 7B shows Bottle filling station 160 with sensor 210. Sensor 210 may emit first beam of light 610 and second beam of light 620. First beam of light 610 and second beam of light 620 may be directed into a detection zone, while avoiding obstacles, like a water bottle. First beam of light 610 and/or second beam of light 620 may be designed to detect water bottles, hands, arms or other objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A sensor comprising:
a first transmitter configured to emit first light;
a second transmitter configured to emit second light;
a first material, located above the first transmitter, configured to redirect the first light into a detection zone;
a second material, located above the second transmitter, configured to redirect the second light into the detection zone; and
a receiver configured to receive light reflected from an object in the detection zone.

2. The sensor of claim 1, wherein:
the first material comprises a first diffractive film; and
the second material comprises a second diffractive film.

3. The sensor of claim 1, wherein:
the first material comprises a first cutaway to allow the second light to pass without interference; and
the second material comprises a second cutaway to allow the first light to pass without interference.

4. The sensor of claim 1, wherein:
the first material comprises a first refractive lens; and
the second material comprises a second refractive lens.

5. The sensor of claim 1, further comprising:
a lens, located above the receiver, configured to focus light on the receiver.

6. The sensor of claim 1, wherein the sensor is configured to determine that an object is in the detection zone based on the reflected light satisfying a threshold.

7. The sensor of claim 1, further comprising:
a housing comprising:
a first compartment for the first transmitter and the second transmitter; and
a second compartment for the receiver, wherein the first compartment and a second compartment are separated by an opaque wall configured to prevent light from passing through.

8. The sensor of claim 7, wherein the housing comprises a window that is translucent in the infrared spectrum.

9. The sensor of claim 8, wherein the window comprises a baffle configured to prevent crosstalk between the first compartment and the second compartment.

10. The sensor of claim 1, wherein:
the first transmitter comprises a first infrared light emitting diode;
the second transmitter comprises a second infrared light emitting diode; and
the receiver comprises a photodiode.

11. A device comprising:
a communication interface configured to communicate with a server without using a bridge; and
a sensor comprising:
a first transmitter configured to emit first light;
a second transmitter configured to emit second light;
a first refractive or diffractive material, located above the first transmitter, configured to redirect the first light into a detection zone;
a second refractive or diffractive material, located above the second transmitter, configured to redirect the second light into the detection zone; and
a receiver configured to receive light reflected from an object in the detection zone.

12. The device of claim 11, wherein the communication interface comprises a wireless communication interface.

13. The device of claim 11, wherein the communication interface is further configured to provide information about the device to the server.

14. The device of claim 11, wherein the communication interface is further configured to receive commands from the server.

15. The device of claim 11, wherein the device comprises at least one of: a faucet, a soap dispenser, a hand dryer, a paper towel dispenser, a flushometer, an air freshener, a water dispenser, a water fountain, a bottle filler, or a water bubbler.

16. A system comprising:
a device comprising:
a communication interface configured to communicate with a server without using a bridge; and
a sensor comprising:
a first transmitter configured to emit first light;
a second transmitter configured to emit second light;
a first refractive or diffractive material, located above the first transmitter, configured to redirect the first light into a detection zone;
a second refractive or diffractive material, located above the second transmitter, configured to redirect the second light into the detection zone; and
a receiver configured to receive light reflected from an object in the detection zone; and
a server configured to provide a dashboard that provides information about the device.

17. The system of claim 16, wherein the device comprises at least one of: a faucet, a soap dispenser, a hand dryer, a paper towel dispenser, a flushometer, an air freshener, a water dispenser, a water fountain, a bottle filler, or a water bubbler.

18. The system of claim 16, wherein the device is configured to provide information about the device to the server.

19. The system of claim 16, wherein the server is configured to send commands to the device, wherein the commands are received via the dashboard.

20. The system of claim 16, further comprising a second device comprising:
a second communication interface configured to communicate with the server without using a bridge; and
a second sensor comprising:
a third transmitter configured to emit third light;
a fourth transmitter configured to emit fourth light;
a third refractive or diffractive material, located above the third transmitter, configured to redirect the third light into a second detection zone;
a fourth refractive or diffractive material, located above the fourth transmitter, configured to redirect the fourth light into the second detection zone; and
a second receiver configured to receive light reflected from an object in the second detection zone.
